(19) United States
(12) Patent Application Publication
(10) Pub. No.: US 2007/0131120 A1
(43) Pub. Date: Jun. 14, 2007

(54) Infuser assembly for preparing beverage in container with narrow opening

(76) Inventor: Mark Hubbard, Costa Mesa, CA (US)

Correspondence Address: HARNESS, DICKEY & PIERCE, P.L.C., P.O. BOX 828, BLOOMFIELD HILLS, MI, 48303, US

(21) Appl. No.: 11/301,107

(22) Filed: Dec. 12, 2005

(51) Int. Cl. A47J 31/44

(52) U.S. Cl. 99/279

(57) ABSTRACT

An infuser assembly adapted for preparation of an infused beverage in a container with a narrow opening. The infuser assembly includes an infuser having a membrane and an ingredient encapsulated therein. The ingredient is suitable for infusion of a substance into a liquid, and the infuser has an elongate shape such that the infuser can move through the opening of the container.

### BACKGROUND OF THE INVENTION

1. Field of the Invention

The present invention relates, generally, to an infuser assembly, and more specifically, to an infuser assembly suitable for preparing a beverage in a container with a narrow opening.

2. Description of the Related Art

Infused beverages are widely consumed. For instance, many people enjoy drinking tea on a regular basis. To brew tea, water is infused with the extracts of tealeaves. An infuser assembly, such as a disposable teabag can be used for brewing tea. The typical teabag includes a permeable membrane or bag, in which a measured amount of tealeaves are enclosed. When placed in water, extracts from the tealeaves eventually move through the membrane and are infused into the water. The teabag may also include a retrieval member, such as a string, used to retrieve the bag from the water once the tea is brewed. Once prepared, tea and other infused beverages are pleasant tasting and can even impart health benefits to drinkers.

Some people drink infused beverages from relatively small, portable containers for convenience. Prepared teas, for instance, are sold in single-portion glass or plastic bottles. However, these bottled teas are not as fresh as some consumers would like, and they can contain artificial sweeteners and other undesirable ingredients. Persons desiring fresher tea can pour freshly brewed tea into a bottle, but this can be inconvenient and time consuming. Another approach is to attempt to brew tea directly inside a bottle full of water. However, most teabags are too large to fit through the relatively narrow opening of a conventional water bottle without first being folded or rolled. Folding and/or rolling the teabag can tear the bag and cause tealeaves to be released into the water. Also, once the teabag is submerged inside the water bottle, the teabag may swell in size, thereby inhibiting removal of the teabag from the water bottle. Thus, a need developed for an infuser that could be more easily inserted and removed from a container having a narrow opening.

In partial response to this need, some teabags were developed that could be inserted into the relatively narrow opening of a container for brewing tea directly therein. For instance, U.S. Pat. No. 6,372,270 to Denny describes cylindrical and spherical teabags that can be inserted into a bottle. However, the teabags of the Denny '270 patent may be difficult to manipulate and/or remove from the bottle. For example, the teabags include a string, which may prove difficult to grab when moving the teabag. The string may also inadvertently fall into the bottle, further complicating removal of the teabag from the bottle. Also, the teabags of the Denny '270 patent may not submerge into the water in a desired manner. For instance, the teabag may float on the surface of the water, or the teabag may only partially submerge, and preparation time may increase as a result. U.S. Pat. No. 1,489,806 to Anderson also discloses elongate teabags, but these teabags are held by the user and suspended within a teacup. As a result, the teabags of the Anderson '806 patent may be inconvenient to hold and retrieve from a container having a narrow opening because the teabag may fall completely into the container. In addition, the teabags of the Anderson '806 patent may not submerge into water in a desirable manner and may instead float or only partially submerge within water.

Accordingly, there remains a need for an infuser assembly that can be easily inserted into and removed from the relatively narrow opening of a container and that is easier to manipulate. There is also a need for an infuser assembly that is easier to retrieve from such containers once the beverage is brewed to a desired strength. There also remains a need for an infuser assembly that can be easily inserted into and removed from a container with a narrow opening that is more likely to submerge in the liquid of the container in a desirable manner. For instance, there remains a need for an infuser assembly that readily breaks the surface tension of the liquid and that submerges readily within the liquid.

### SUMMARY OF THE INVENTION

The disadvantages of the related art are overcome in an infuser assembly adapted for preparation of an infused beverage in a container with a narrow opening. The infuser assembly includes a retrieval member suitable for extending through the opening of the container. The infuser assembly also includes a handling member that is wider than the retrieval member and that is attached to the retrieval member. The infuser assembly further includes an infuser that includes a membrane and an ingredient encapsulated therein. The membrane is attached to the retrieval member, and the ingredient is suitable for infusion of a substance into a liquid. In addition, the infuser has an elongate shape such that the infuser can move through the opening of the container.

In another aspect, the present invention is an infuser assembly adapted for preparation of an infused beverage in a container with a narrow opening. The infuser assembly includes a retrieval member suitable for extending through the opening of the container and an infuser. The infuser includes a membrane and an ingredient encapsulated therein. The ingredient is suitable for infusion of a substance into a liquid. The infuser has an elongate shape such that the infuser can move through the opening of the container. Also, the membrane defines a first end and a second end opposite to the first end, wherein the retrieval member is attached to the membrane adjacent the first end, and the second end of the membrane is tapered and terminates at a point.

In still another aspect, the present invention is an infuser assembly adapted for preparation of an infused beverage in a container with a narrow opening. The infuser assembly includes an infuser having a membrane and an ingredient encapsulated therein. The ingredient is suitable for infusion of a substance into a liquid, and the infuser has an elongate shape such that the infuser can move through the opening of the container. Also, the membrane defines a first end and a second end opposite to the first end, and the second end of the membrane weighs more than the first end of the membrane.

The infuser assembly allows for an infused beverage to be prepared directly inside a container with a relatively narrow opening for convenience in transporting and consuming the infused beverage. The infuser assembly is also easier to grab and handle by the user. Furthermore, the infuser assembly is unlikely to fall completely within the container so that a user may retrieve the infuser assembly from the container. Moreover, the infuser of the infuser assembly more readily submerges within the liquid of the container for improved brewing of the infused beverage.

### BRIEF DESCRIPTION OF THE DRAWINGS

Other advantages of the invention will be readily appreciated as the same becomes better understood by reference to the following detailed description when considered in connection with the accompanying drawings, wherein:

FIG. 1 is an elevational view of an infuser assembly of the present invention illustrated in connection with a container having a narrow opening;

FIG. 2 is an elevational view of another embodiment of an infuser assembly of the present invention illustrated in connection with a container having a narrow opening; and

FIG. 3 is an elevational view of another embodiment of an infuser assembly of the present invention illustrated in connection with a container having a narrow opening.

### DETAILED DESCRIPTION OF THE PREFERRED EMBODIMENT(S)

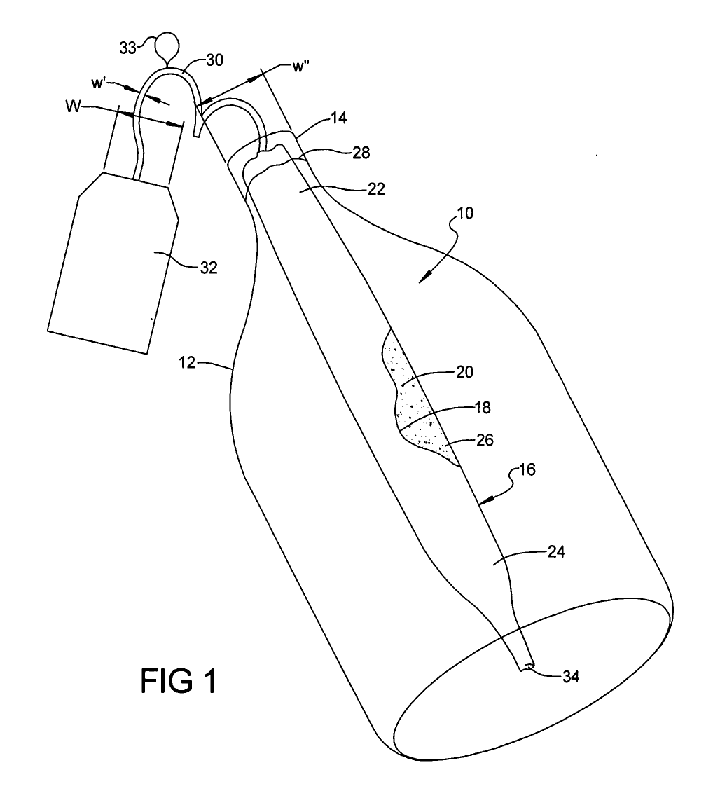

Referring now to the drawings, where like numerals are used to designate like structure throughout the figures, an infuser assembly is generally indicated at 10 in FIG. 1. The infuser assembly 10 is adapted for preparation of an infused beverage in a container 12 with a relatively narrow opening 14, such as a necked bottle. However, those having ordinary skill in the art will appreciate that the type of container 12 with which the infuser assembly 10 is used does not limit the scope of the present invention.

The infuser assembly 10 includes an infuser 16 having an elongate shape such that the infuser assembly 10 can move through the relatively narrow opening 16 of the necked container 12. In the embodiment shown, the infuser 16 is generally cylindrical, but those having ordinary skill in the art will appreciate that the infuser 16 could be of any other suitable elongate shape, such as rectangular or otherwise, without departing from the scope of the invention. As such, the infuser assembly 10 can be used to prepare an infused beverage directly in the container 12 as will be described in greater detail below. The shape of the infuser 16 also advantageously allows a plurality of infuser assemblies 10 to be used within a single container 12. In addition, the elongate shape of the infuser 16 also exposes a larger surface area of the infuser for reduced brewing time.

In the embodiment shown, the infuser 16 includes a membrane 18 and an ingredient 20 encapsulated within the membrane 18. The membrane 18 provides the infuser 16 with an elongate shape, and the membrane 18 defines a first end 22 and a second end 24 opposite to the first end 22. The membrane 18 can be made of any suitable material, such as paper. The membrane 18 is also substantially hollow so as to form a chamber 26 therein. The ingredient 20 is encapsulated within the chamber 26 of the membrane 18. The ingredient 20 can be of any type suitable for infusion of a substance into a liquid 28. For instance, in one embodiment, the ingredient 20 is a pre-measured amount of tealeaves, and when the infuser 16 is submerged in liquid 28 within the container 12, extracts from the tealeaves pass through the membrane 18 to be introduced into the liquid 28 to prepare a tea beverage. However, those having ordinary skill in the arts will appreciate that the ingredient 20 could be of any suitable type without departing from the scope of the invention. For instance, the ingredient 20 could be coffee, natural or artificial flavoring, vitamins, minerals, and the like.

The infuser 16 can be formed in any suitable manner. For instance, in one embodiment, the membrane 18 is a rectangular sheet that is rolled such that the membrane 18 takes on an elongate shape. The ingredient 20 can be deposited on the membrane 18 before rolling, or the membrane 18 can be rolled to form the chamber 26, and then the ingredient 20 can be subsequently inserted into the chamber 26. Once rolled, openings in the membrane 18 can be sealed in any suitable manner, such as heat crimping, fasteners, adhesives, or the like.

In the embodiment shown, the infuser assembly 10 also includes a retrieval member 30 suitable for extending through the opening 14 of the container 12. The retrieval member 30 is attached to the membrane 16 adjacent the first end 22. The retrieval member 30 can be attached to the membrane 16 in any suitable fashion, such as heat crimping, adhesives, fasteners, and the like. In one embodiment, the retrieval member 30 is a string, but those having ordinary skill in the art will appreciate that the retrieval member 30 could be of any suitable type without departing from the scope of the invention. The retrieval member 30 is preferably long enough to extend out of the container 12 when the infuser 16 is disposed within the container 12 such that the retrieval member 30 can be used to pull the infuser 16 from the container 12. Iin one embodiment, the length of the retrieval member 30 is selected according to the height of the container 12. For instance, if the infuser assembly 10 is more likely to be used in taller containers 12, the retrieval member 30 can be longer such that the retrieval member 30 is less likely to inadvertently fall into the container 12 when the infuser 16 is disposed inside the container 12.

The infuser assembly 10 also includes a handling member 32. The handling member 32 is generally flat. The handling member 32 is attached to the retrieval member 30 away from the first end 22 of the membrane 18. The handling member 32 can be attached to the retrieval member 30 in any suitable fashion, such as heat crimping, adhesives, fasteners, and the like. The handling member 32 is made of paper in one embodiment. The handling member 32 is wider than the retrieval member 30. More specifically, as shown in FIG. 1, the width dimension W of the handling member 32 is greater than the width dimension w′ of the handling member 32. The width of the handling member 32 allows a user to more easily grab the handling member 32 such that the infuser assembly 10 can be more easily handled during use.

In one embodiment, the handling member 32 is wider than the opening 14 of the container 12. More specifically, as shown in FIG. 1, the width dimension W of the handling member 32 is greater than the width dimension w″ of the opening 14 of the container 12. In one embodiment, the handling member 32 is wider than approximately one-and-one-eighth (1⅛) inches. As such, when the infuser assembly 10 is inserted into the container 12, and if the retrieval member 30 falls into the container 12, the handling member 32 will interfere with the opening 14 of the container and preferably remain outside the container 12. This ensures that a user will be able to grab the handling member 32 and pull the infuser assembly 10 away from and out of the container 12. Accordingly, the infuser assembly 10 is unlikely to inadvertently fall completely within the container 12.

In addition, the infuser assembly 10 includes an elastic band 33 coupled to the retrieval member 30. When the infuser 16 is inserted into the container 12, the elastic band 33 can be stretched around the outside of the container 12. In one embodiment, the elastic band 33 is sized so as to grip the outside of the container 12. As such, the elastic band 33 is adapted for coupling the retrieval member 30 to the container 12, and the retrieval member 30 is more likely to remain outside of the container 12 so that the user can utilize the retrieval member 30 for removing the infuser assembly 10 from the container 12.

In the embodiment shown in FIG. 1, the second end 24 of the membrane 18 is tapered and terminates at a point 34. The tapered second end 24 and the point 34 can be formed in any suitable manner. For instance, in one embodiment, the ingredient 20 is not disposed adjacent the second end 24. This leaves the chamber 26 substantially empty adjacent the second end 24, thereby allowing the second end 24 to be pinched and twisted so as to form the tapered second end 24 and the point 34. In another embodiment, the membrane 18 is a strip of material wound around a mandrel (not shown), and the second end 24 of the second end 24 is wound tightly around the mandrel so as to be tapered. Because the second end 24 is tapered and includes the point 34, the infuser assembly 10 readily breaks the surface tension of the liquid 28 in the container 12. As such, the infuser 16 submerges within the liquid 28 in a desired manner for improved brewing of the infused beverage.

Furthermore, the second end 24 of the membrane 18 weighs more than the first end 22 of the membrane 18. More specifically, the second end 24 of the membrane 18 is packed compactly due to the tapering so that there is more material used for the membrane 18 at the second end 24 as compared to the first end 22. Because the second end 24 is heavier than the first end 22, the infuser 16 more readily submerges within the liquid 28 for improved brewing of the infused beverage.

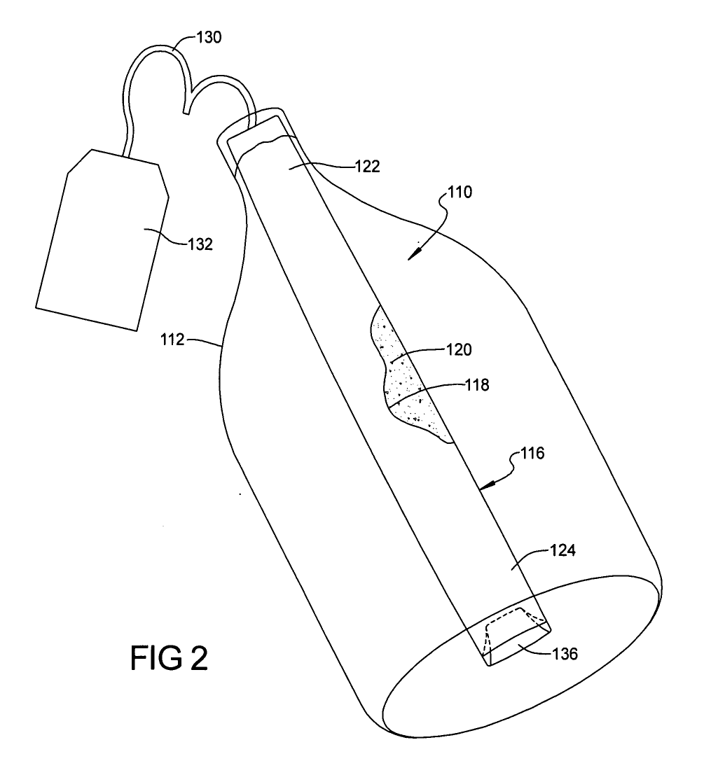

Turning now to FIG. 2, another embodiment of an infuser assembly is generally indicated at 110 where like numerals increased by 100 are used to designate like structure with respect to the embodiment illustrated in FIG. 1. The infuser assembly 110 includes an infuser 116 with a membrane 118 and an ingredient 120 encapsulated within the membrane 118. The infuser 116 has an elongate shape. The membrane 118 defines a first end 122 and a second end 124 opposite to the first end 122. In the embodiment shown, the second end 124 of the membrane 118 includes at least one fold 136 such that the second end 124 weighs more than the first end 122. More specifically, the membrane 118 is folded such that the second end 124 includes more material used for the membrane 118 as compared to the first end 122. As such, the second end 124 weighs more than the first end 122. The fold 136 could be formed in any suitable manner. For instance, in one embodiment, the membrane 118 is a rectangular sheet on which the ingredient 120 is deposited, the membrane 118 is folded at least once on a side that ultimately becomes the second end 124, and then the membrane 118 is rolled in the direction of the folded side so as to encapsulate the ingredient 120 and so as to create the fold 136. Because the second end 24 is heavier than the first end 22, the infuser 16 more readily submerges within the liquid 28 for improved brewing of the infused beverage.

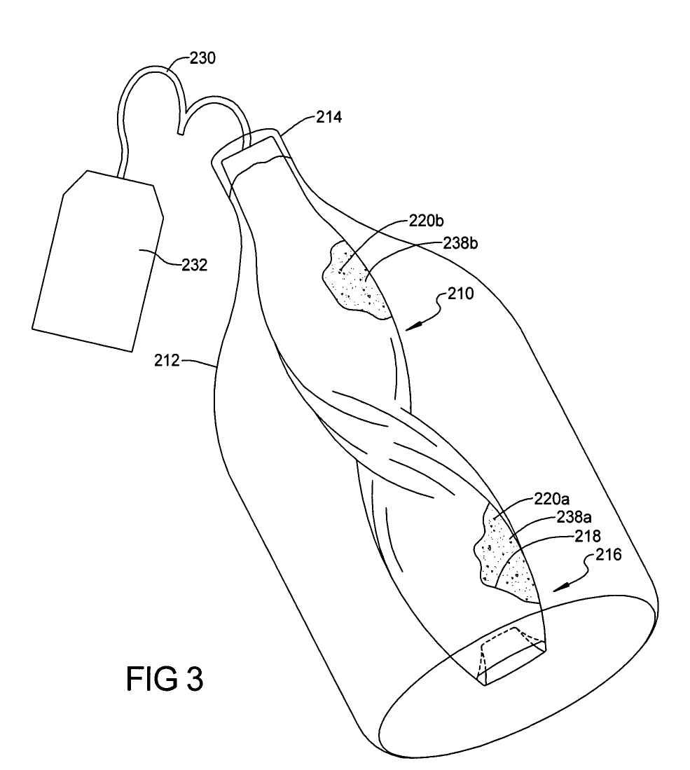

Turning now to FIG. 3, another embodiment of the infuser assembly is generally indicated at 210, where like numerals increased by 200 indicate like structure with respect to embodiment shown in FIG. 1. The infuser assembly 210 includes an infuser 216 with a membrane 218. The membrane 218 is elongate and includes a plurality of chambers 238a, 238b. Each of the chambers 238a, 238b are suitable for separately encapsulating an ingredient 220a and 220b. The chambers 238a, 238b can be formed in any suitable manner. For instance, in one embodiment, the membrane 218 is a rectangular sheet that is rolled so as to form the elongate shape, and the membrane 218 is twisted about its longitudinal axis so as to form the chambers 238a, 238b. Ingredients 220a, 220b can subsequently be inserted into the chambers 238a, 238b. The chambers 238a, 238b can each hold separate ingredients 220a, 220b to vary the type of infused beverage.

In summary, the infuser assembly 10, 110, 210 allows for an infused beverage to be prepared directly inside a container 12, 112, 212 with a relatively narrow opening 14, 114, 214 for convenience in transporting and consuming the infused beverage. The infuser assembly 10, 110, 210 is also easier to grab and handle due to the handling member 32, 132, 232. Furthermore, the infuser assembly 10, 110, 210 is unlikely to fall completely within the container 12, 112, 212 so that a user may retrieve the infuser assembly 10, 110, 210 from the container 12, 112, 212. Moreover, the infuser 16, 116, 216 of the infuser assembly 10, 110, 210 more readily submerges within the liquid 28, 128, 228 of the container 12, 112, 212 for improved brewing of the infused beverage.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

We claim:

1. An infuser assembly adapted for preparation of an infused beverage in a container with a narrow opening, said infuser assembly comprising:
a retrieval member suitable for extending through the opening of the container;
a handling member that is wider than said retrieval member, said handling member attached to said retrieval member; and
an infuser that includes a membrane and an ingredient encapsulated therein, wherein said membrane is attached to said retrieval member, wherein said ingredient is suitable for infusion of a substance into a liquid, and wherein said infuser has an elongate shape such that said infuser can move through the opening of the container.

2. An infuser assembly as set forth in claim 1, wherein said membrane defines a first end and a second end opposite to said first end, wherein said retrieval member is attached to said membrane adjacent said first end, and wherein said second end of said membrane is tapered and terminates at a point.

3. An infuser assembly as set forth in claim 1, wherein said membrane defines a first end and a second end opposite to said first end, and wherein said second end of said membrane weighs more than said first end of said membrane.

4. An infuser assembly as set forth in claim 3, wherein said membrane includes at least one fold such that said second end of said membrane weighs more than said first end of said membrane.

5. An infuser assembly as set forth in claim 1, wherein said handling member is wider than the opening of the container.

6. An infuser assembly as set forth in claim 1, wherein said handling member is wider than approximately one-and-one-eighth (1⅛) inches.

7. An infuser assembly as set forth in claim 1, further comprising an elastic band coupled to said retrieval member, said elastic band adapted for coupling said retrieval member to the container.

8. An infuser assembly as set forth in claim 1, wherein said membrane includes a plurality of chambers each suitable for separately encapsulating an ingredient.

9. An infuser assembly adapted for preparation of an infused beverage in a container with a narrow opening, said infuser assembly comprising:
a retrieval member suitable for extending through the opening of the container; and
an infuser that includes a membrane and an ingredient encapsulated therein, wherein said ingredient is suitable for infusion of a substance into a liquid, wherein said infuser has an elongate shape such that said infuser can move through the opening of the container, wherein said membrane defines a first end and a second end opposite to said first end, wherein said retrieval member is attached to said membrane adjacent said first end, and wherein said second end of said membrane is tapered and terminates at a point.

10. An infuser assembly as set forth in claim 9, wherein said membrane defines a first end and a second end opposite to said first end, and wherein said second end of said membrane weighs more than said first end of said membrane.

11. An infuser assembly as set forth in claim 10, wherein said membrane includes at least one fold such that said second end of said membrane weighs more than said first end of said membrane.

12. An infuser assembly as set forth in claim 9, wherein said membrane defines a first end and a second end opposite to said first end, wherein said retrieval member is attached to said membrane adjacent said first end, and wherein said second end of said membrane is tapered and terminates at a point.

13. An infuser assembly as set forth in claim 9, further comprising a handling member attached to said retrieval member, said handling member wider than the opening of the container.

14. An infuser assembly as set forth in claim 13, wherein said handling member is wider than approximately one-and-one-eighth (1⅛) inches.

15. An infuser assembly as set forth in claim 9, further comprising an elastic band coupled to said retrieval member, said elastic band adapted for coupling said retrieval member to the container.

16. An infuser assembly adapted for preparation of an infused beverage in a container with a narrow opening, said infuser assembly comprising:
an infuser that includes a membrane and an ingredient encapsulated therein, wherein said ingredient is suitable for infusion of a substance into a liquid, wherein said infuser has an elongate shape such that said infuser can move through the opening of the container, wherein said membrane defines a first end and a second end opposite to said first end, and wherein said second end of said membrane weighs more than said first end of said membrane.

17. An infuser assembly as set forth in claim 16, wherein said membrane includes at least one fold such that said second end of said membrane weighs more than said first end of said membrane.

18. An infuser assembly as set forth in claim 16, further comprising a retrieval member attached to said membrane and a handling member attached to said retrieval member.

19. An infuser assembly as set forth in claim 16, wherein said membrane is tapered and terminates at a point.

20. An infuser assembly as set forth in claim 16, wherein said handling member is wider than approximately one-and-one-eighth (1⅛) inches.
